(19) United States
(12) Patent Application Publication
(10) Pub. No.: US 2015/0161177 A1
(43) Pub. Date: Jun. 11, 2015

(54) SEARCH RESULT IMAGE PROCESSING

(71) Applicants: Anantica Jija Hari SINGH, San Francisco (CA); Ziga MAHKOVEC, San Francisco, CA (US); Sashanka VISHNUVAJHALA, San Jose, CA (US); Nathan D. BEACH, Sunnyvale, CA (US)

(72) Inventors: Anantica Jija Hari SINGH, San Francisco (CA); Ziga MAHKOVEC, San Francisco, CA (US); Sashanka VISHNUVAJHALA, San Jose, CA (US); Nathan D. BEACH, Sunnyvale, CA (US)

(73) Assignee: Google Inc., Mountain View, CA (US)

(21) Appl. No.: 13/495,596

(22) Filed: Jun. 13, 2012

(51) Int. Cl. G06F 17/30; G06F 3/0484

(52) U.S. Cl. CPC G06F 17/30277; G06F 3/04842

(57) ABSTRACT

Methods, systems, and apparatus, including computer programs encoded on a computer storage medium, for processing image search results. In one aspect, a method includes rendering a page resource referenced by a selected image search result and received in response to the selection of the image search result in a second display environment to generate a rendered page resource in the second display environment, the second display environment being a display environment that is separate from a first display environment in which the image search results are displayed, generating, from the rendered page resource in the second display environment, an image of the rendered page resource, displaying, in the first display environment, the image of the rendered page resource, and in response to a command navigate to the page resource, transitioning the rendered page resource to the first display environment to display the page resource.

### BACKGROUND

This specification relates to information presentation.

The Internet provides access to a wide variety of resources. For example, digital image files, video and/or audio files, as well as web pages for particular subjects or particular news articles, are accessible over the Internet. A variety of search engines are available for identifying particular resources accessible over the Internet. For example, digital images that satisfy a user's informational need can be identified by an image search process in which keywords or other data are processed to identify collections of digital images. Each image is identified to the user by an image search result. An image search result references a corresponding image resource that a search engine determines to be responsive to a search query, and typically includes a representative image of the image resource, such as a thumbnail. The image search result also references a page resource that includes the image resource.

### SUMMARY

Selection of an image search result causes the user device to request the page resource. Some search engines, however, present the image in an interstitial form instead of transitioning the browser to the page resource. For example, a search engine may cause a browser to render the page resource requested from a server that belongs to a particular domain in an iFrame that belongs to the domain of the search engine, and that is different from the domain of the server from which the page resource was requested. The image resource that is included in the page resource is rendered in an image overlay environment that is the top level page of the browser. This allows the user to view a version of the image that is larger than the version that is presented in the image search result, and also provides the user with some context of the page resource in which the image is displayed. However, should the user close the image overlay environment to view the underlying page resource, the iFrame that is being used to display the page resource is also closed. Accordingly, the browser issues another request to the server hosting the page resource. This specification describes technologies relating to processing image search results in a manner in which the requests to the server hosting the page resource are not duplicated in response to the selection of an image search result.

In general, one innovative aspect of the subject matter described in this specification can be embodied in methods that include the actions of displaying a plurality of image search results in a search results page displayed in a first display environment, the first display environment being a display environment in which content is displayed to a user, each image search result referencing a corresponding image resource that is determined to be responsive to a search query and including a representative image of the image resource, and referencing a page resource that includes the image resource, and wherein a selection of an image search result causes the user device to request the page resource; in response to a selection of one of the image search results: rendering the page resource referenced by the selected image search result and received in response to the selection of the image search result in a second display environment to generate a rendered page resource in the second display environment, the second display environment being a display environment that is separate from the first display environment; generating, from the rendered page resource in the second display environment, an image of the rendered page resource; displaying, in the first display environment, the image of the rendered page resource; and in response to a command navigate to the page resource, transitioning the rendered page resource to the first display environment to display the page resource. Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. The subject matter of this application solves the technical problem of minimizing requests to a server hosting a page resource resulting from the selection of an image search result that references the page resource. In particular, when the image of a page resource that has been rendered in a hidden display environment is displayed in a viewed display environment, and then the rendered page is transitioned into the viewed display environment, a subsequent request for the page resource need not be generated, thereby reducing latency inherent in the re-rendering of the page resource. This also makes for a more fluid user experience, as the user may transition his or her attention directly from the image of the underlying background rendered page resource in the display environment to the actual page resource without being distracted by the re-rendering of the page resource.

Additionally, server traffic metrics are not artificially inflated by duplicate requests resulting from the user selections of image search results, thereby readily facilitating more accurate web traffic reporting and web traffic analytics.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in image search results are processed.

FIGS. 2A-2C are illustrations of example user interfaces presented during the processing of an image search result.

FIG. 3 is a flowchart of an example process for processing an image search result.

FIG. 4 is a flowchart of an example process for generating and displaying incremental images.

Like reference numbers and designations in the various drawings indicate like elements.

### DETAILED DESCRIPTION

Overview

An image search result includes a representation of an image, the address of the image, and the address of a web page that includes the image. The representation of the image, can, for example, be a scaled version of the image, such as a thumbnail. The image search result is shown on an image search results page in a user device application, such as a browser.

The browser includes instructions that are executed by the user device. The instructions cause the browser to display image search results in a first display environment, e.g., a web page for search results shown in an active browser window or active browser tab. In response to a selection of an image search result, the browser requests the web page resource that includes the image referenced in the image search result. Upon receiving the web page resource, the browser renders the page resource in a second display environment to generate a rendered page resource in the second display environment. In some implementations, the second display environment is one that is not displayed to the user, e.g., a “hidden tab”, or a background tab, and is a separate display environment from the first display environment.

The rendering of the page resource in the second display environment is referred to as “background rendering”. The rendering of the page resource in the second display environment results in a portion of the memory of the user device storing the data necessary to display the rendered page resource. Thus, in response to a command to display the rendered page resource, the rendered page resource may be displayed with very little delay.

Using the rendered web page resource, the browser generates an image of the rendered page resource. For example, the browser may generate an image of the rendered page resource that is an image how the page resource would appear if it were actually rendered in the first display environment. The browser then displays the image of the rendered page resource in the first display environment. From the user's perspective, it appears as though the page resource is actually displayed in the first display environment. If the browser receives a command to navigate to the page resource, then the browser transitions the previously rendered page resource to the first display environment to display the actual page resource.

Additionally, the instructions cause the browser to create an image display an overlay image in the first display environment that is rendered atop the web page in the browser, e.g., with precedence with respect to the web page. The overlay is populated with the image that is referenced by the search result, and, optionally, metadata describing additional information about the image, the web site that includes the web page, and other data. Selecting a “close” command for the image overlay (or any other command that signals a desire to navigate to the page hosting the image, such as clicking on web page in the background) results in the generation of the command to navigate to the page resource described above.

The above-described process is useful for previewing an image of an image search result in the context of the web page resource that hosts the image. However, by displaying an image of the actual page resource with the overlay, and then transitioning the previously rendered page resource into the first display environment in response to a command to navigate to the page resources, requests to the server hosting the page resource are not duplicated in response to the command.

The processing of the image search results is described in more detail below.

Example Environment

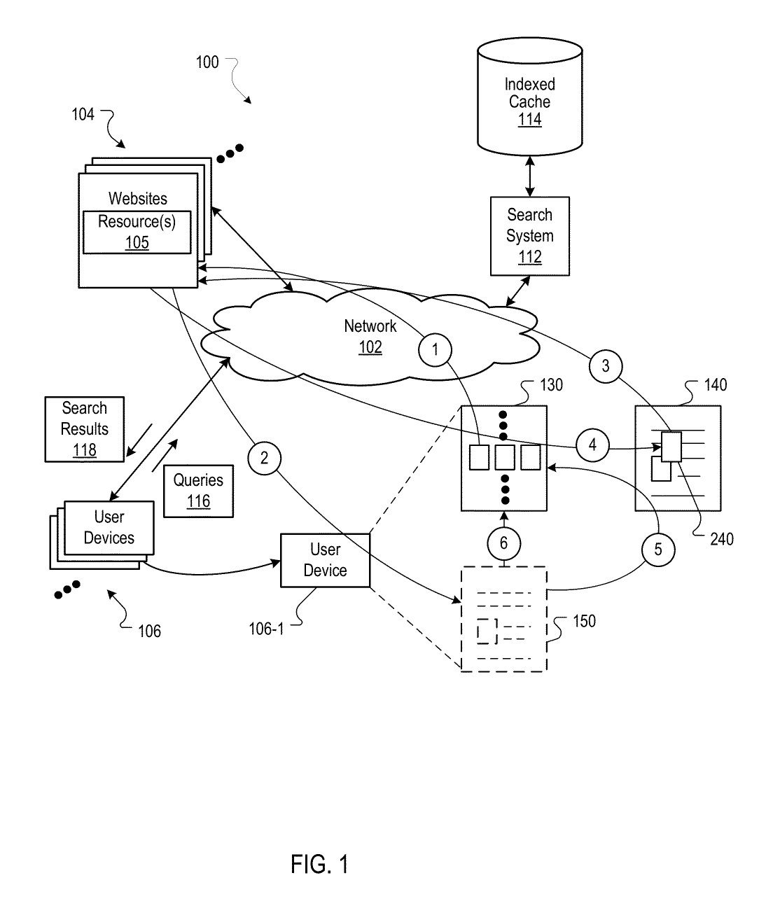

FIG. 1 is a block diagram of an example environment 100 in which systems implementing the subject matter of this written description are implemented. A network 102, such as a local area network (LAN), a wide area network (WAN), the Internet, or a combination thereof, connects websites 104, user devices 106, and a search engine 112.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a content publisher, which is an entity that controls, manages and/or owns the website 104.

A resource 105 can be any data that can be provided over the network 102. A resource 105 can be identified by a resource address that is associated with the resource 105. Resources include HTML pages, images, portable document format (PDF) documents, videos, and feed sources, to name only a few. Additionally, resources such as web page resources can, in turn, reference other resources such as images so that when the web page resource is rendered on a user device, the referenced image is also displayed.

A user device 106 is an electronic device that is under control of a user and is capable of requesting and receiving resources over the network 102. Example user devices 106 include personal computers, mobile communication devices (e.g., smartphones), and other devices that can send and receive data over the network 102. A user device 106 typically includes one or more user applications, such as a web browser, to facilitate the sending and receiving of data over the network 102. By use of these applications, a user device 106 can request resources 105 from a website 104. In turn, the resource 105 can be provided to the user device 106 for presentation by the user device 106.

To facilitate searching of these resources, a search system 112 identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

For images, the search system 112 utilizes image processing algorithms to identify multiple instances of the same image. The search system 112, in some implementations, then selects a representative image (e.g., a canonical image) that is used to represent each of the identical images, and associates the representative image with each of the underlying identical images. The underlying web page that is referenced in the image search result is determined at query time, as a particular query may include information that results in one particular web page being selected over other web pages that include the same image.

At query time, the user devices 106 submit search queries 116 to the search system 112 over the network 102. In response, the search system 112 accesses the indexed cache 114 to identify resources that are relevant to the search query 116. The search system 112 identifies the resources in the form of search results 118 and returns the search results 118 to the user devices 106 in search results pages. Each search result page typically includes multiple search results.

Processing Image Search Results

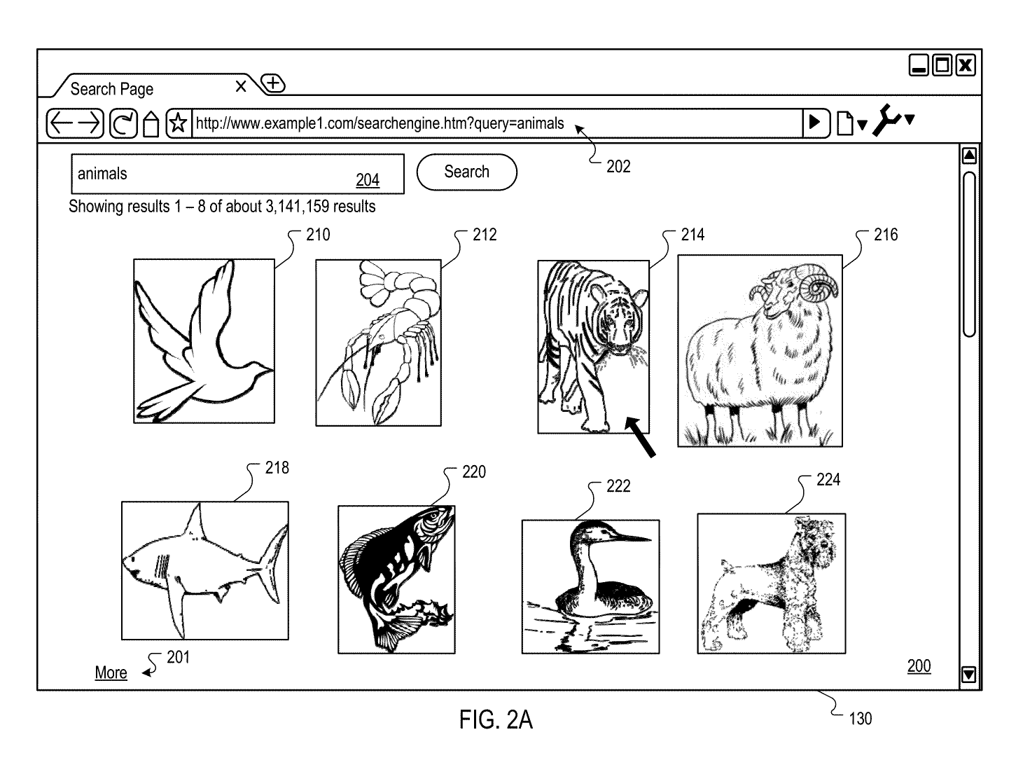

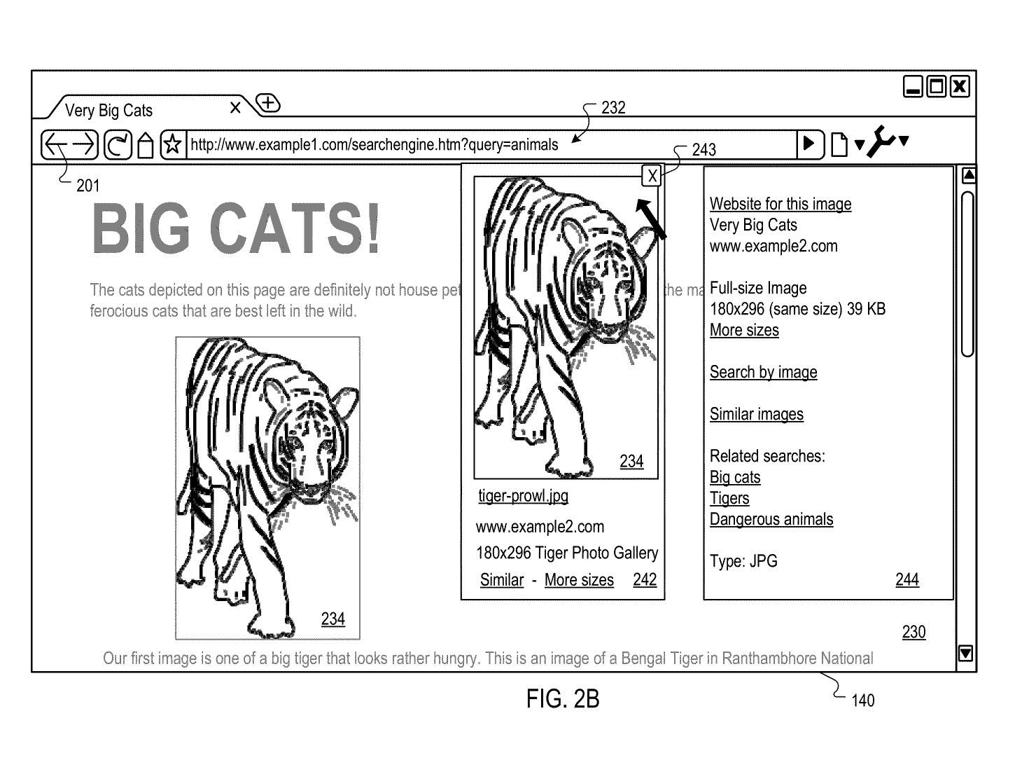

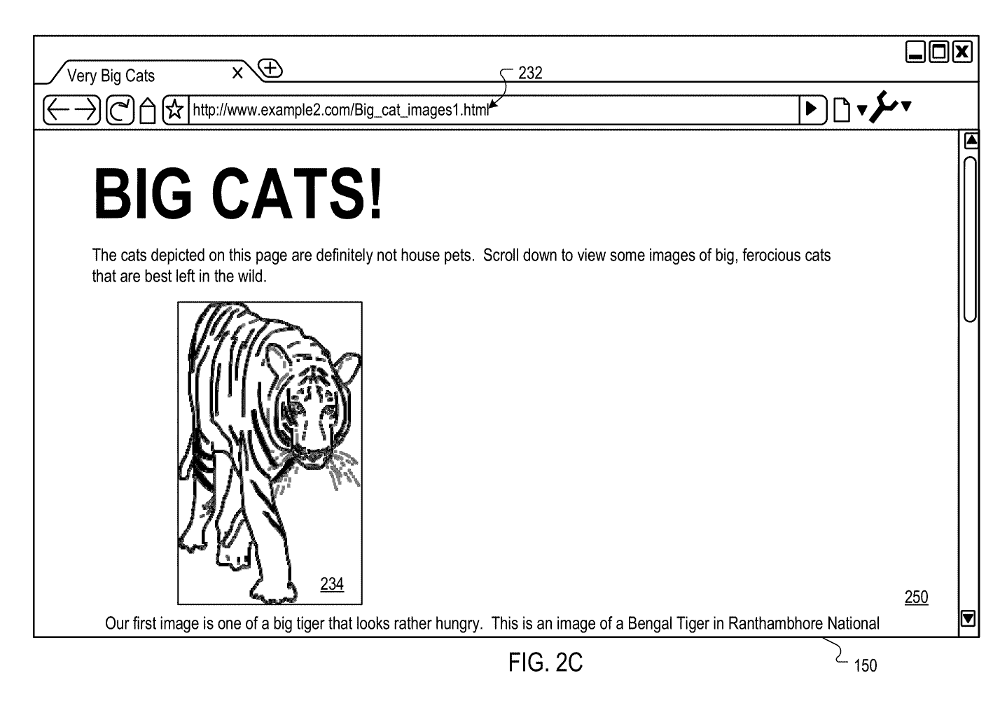

The processing of image search results on a user device is depicted with reference to the user device 106-1 and the three user interface representations 130, 140 and 150. The three user interface representations 130, 140 and 150 depict the progression from an image search results page (shown in user interface130) to an underlying page resource (shown in user interface 150) that includes an image referenced in a selected search result. The user interface representations 130, 140 and 150 are shown in more detail in FIGS. 2A-2C, which are illustrations of the example user interfaces 130, 140 and 150 presented during the processing of an image search result.

In response to a query, the search system 112 provides search results 118 to the user device 106-1. As depicted in the user interface 130 in FIG. 2A, the user device 106-1 is displaying a search results page 200. The example URL 202 represents the URL of the search results page 200 served by the search system 112. In response to the query 204 “animals”, the search system 112 has provided image search results 210, 212, 214, 216, 218, 220, 222 and 224. Each image search result references a corresponding image resource that is determined to be responsive to a search query and includes a representative image of the image resource. For example, each image shown in the search results page 200 may be a smaller version of a corresponding image provided by a corresponding website 104. Each search result references a page resource 105 that includes the image resource. Most often the page resources is, for example, an HTML page that references the image resource so that when the HTML page is rendered on a user device, the image is displayed with additional content. However, the page resource may, in some situations, be the same as the image resource.

Additional image search results may be made available by selecting the “More” link 201, or, alternatively, by scrolling down the search results page 200 to change the active portion of the viewport. As shown in the user interface 130, the user has positioned the cursor over the image search result 214. The search results are displayed in a first display environment that is an active browser window or active browser tab. As used herein, the active window (or active tab) is a currently focused display environment of an application.

In some implementations, the browser application running on the user device 106-1 includes instructions that facilitate the processing of search results as described in more detail below. The instructions can be provided in a variety of different ways. For example, the instructions can be part of the browser executable, part of the search results page source, or alternatively can be provided by a browser plug-in, a toolbar application, or even provided in the form of a script with the search results page 200.

In operation, the instructions cause the user device 106-1, in response to a selection of an image search result, to request the page resource referenced by the search result. For example, assume the user selects the image search result 214. As depicted in FIG. 1, the selection causes the user device 106-1 to send a request for the page resource reference by the search result. The request is denoted by data flow element 1 in FIG. 1.

In response, the server hosting the requested page resource serves the page resource to the user device 106-1, as denoted by data flow element 2 in FIG. 1. The instructions executing on the user device cause the user device to render, in a second display environment, the page resource referenced by the selected image search result and received in response to the selection of the image search result. The second display environment is a display environment that is separate from the first display environment. In some implementations, the second display environment is hidden from view of the user.

When the user selects an image search result, the user does not necessarily intend to navigate to the page resource. Instead, the interaction model of an image search result involves the generation of a larger representation of the image as an overlay to a background display of the page resource hosting the image. This allows the user to view the context in which the image is presented. Should the user decide to navigate to the page resource hosting the image, the user “closes” the overlay by selecting a close command, or by some other command that signals a desire to navigate to the page that includes the image. Conversely, should the user decide to return to the search results page, the user selects the browsers “back” command 201.

Rendering in the second display environment, or “background rendering”, is a process by which the browser does all of the rendering processing necessary to show the page resource to the user, but without actually showing the page resource until the user causes the browser to “navigate to” the page resource. The background rendering facilitates a smooth transition from the overlay to the actual rendered page resource, and also facilitates image processing for display an image of the background rendered page resource as a background to the overlay. In some implementations, background rendering behaves similar to if a user clicked on a link on a page and the page opened it in a background tab, and then the user later switched to that tab. In some implementations of background rendering, however, the page is opened in a hidden tab that is hidden from view. When the user causes the browser to navigate to the page resource that has been background rendered, the contents of the second display environment (e.g., the contents of a hidden tab or background tab) are transitioned into the tab the user was viewing (the first display environment). The transitioning does not require another request to the server hosting the page resource.

In an implementation, the browser integrates the background rendering process into the interaction model. In this implementation, the browser also generates an image an image of the background rendered page resource, and displays the image of the background rendered page resource in the first display environment.

In particular, in response to a selection of an image search result, the browser creates an image display environment 240 on the search results page resource, and the image that is referenced by the search result is displayed within the image display environment 240. For example, in some implementations, the image display environment on the page resource is an image overlay environment, such as an iFrame. Once instantiated, the image resource is requested for the overlay environment, as denoted by data flow element 3 in FIG. 1. In response to the request, the server hosting the image resource provides the image resource to the user device 106-1, as denoted by data flow element 4 in FIG. 1. The image display environment 240 displays the image resource and is the top level element in the browser on the user device 106-1.

Additionally, the browser background renders the page resource, as illustrated by the phantom interface 150 in FIG. 1, which depicts the background rendered page resource in memory. The browser also generates an image of the background rendered page resource, and the image is displayed in the first display environment with the image overlay environment. This is graphically depicted in FIG. 1 by the data flow element 5, which shows the image of the page resource overlaid by the overlay environment.

The resulting user interface 140 is shown in detail in FIG. 2B. The search results page resource 200, referenced by the URL address 202, is still the top level page in the browser. However, the search page resource 200 has been modified to include the image 230 of the background rendered page resource that was provided in response to the selection of the image search result 214. The image 230 is, for example, inserted into the document object model (DOM) of the search results page resource 200. The DOM of the search results page resource 200 can be further modified to hide other elements, such as the search results and other information shown in FIG. 2A.

In some implementations, the image 230 may also be de-emphasized, such as by layering the image 230 with a semi-opaque gray mask and as illustrated in FIG. 2B. This causes the user to focus on the image display environment 240.

The image 230 is also rendered subordinate to the image display environment 240, i.e., the image display environment 240 is displayed such that the display of the page resource 200 is subordinate in terms of vertical stacking In FIG. 2B, the overlay environment includes a first portion 242 in which the image resource 234 and image metadata are displayed, and a second portion 244 in which additional metadata are displayed. The image resource 234 is the image resource referenced by the image search result 214, and which is also shown in the page resource 230. The image resource 234 may itself be addressed by a URL that is different from the page resource 230 URL 232. For example, the URL of the image resource may be “www.example2.com/tiger-prowl.jpg.” In some implementations, in addition to the metadata, the first portion 242 of the overlay environment may include links to similar images and different versions of the image 234. Selection of a link may, for example, cause the search system 112 to perform corresponding operations, such as identifying similar images and images of different sizes.

The second portion 244 of the image overlay environment includes additional metadata for the image 234, such as the website hosting the image 234, image size data, links to additional images, similar images, and additional search options. Additional metadata and commands (or fewer commands and metadata) can also be shown.

While the first and second portions 242 and 244 are depicted as separate elements, they are, in some implementations, elements of the same iFrame. In variations of these implementations, the portions 242 and 244 need not be rendered in separate areas, and the portions 242 and 244 can be combined such that the image 234, metadata and commands are shown in a contiguous portion.

In the first portion 242 of the image display environment 240 a close command 243 is displayed. Selection of the close command closes the image display environment 240, and causes the browser to navigate to the page resource referenced by the selected image search result.

The closing of the image display environment 240 is depicted by data flow element 5 of FIG. 1, and the resulting user interface 150 is shown in detail in FIG. 2C, which illustrates the display of the actual page resource 250, as indicated by address 232. However, because the page resource 250 was background rendered in the second display environment, it is transitioned to the first display environment without a duplicate request to the hosting server. Thus, the page resource 250 is displayed in the first display environment without the need to again request the page resource 250 from its hosting sever or re-render the page resource. Because the image 230 of the page resource 250 was previously displayed in the first display environment, the transition of the actual page resource 250 into the first display environment occurs with very little, if any, visual interruption.

In some implementations, the browser transitions the contents of the page resource 250 into the first display environment by taking the contents of the rendered page resource in memory and associating the active window with the contents. Accordingly, the previously displayed information is removed and replaced with the contents of the actually rendered page resource 250. In other implementations, the browser simultaneously closes the first display environment and causes the second display environment to become the active display environment. As a result, the second display environment becomes visible and the content displayed in the hidden tab is displayed to the user.

While the examples above have been described in the context of a particular addressing and retrieval scheme (i.e., URLs), other addressing schemes can also be used. For example, other types of URIs may be utilized and images may be processed using data URI's, etc.

Example Processes

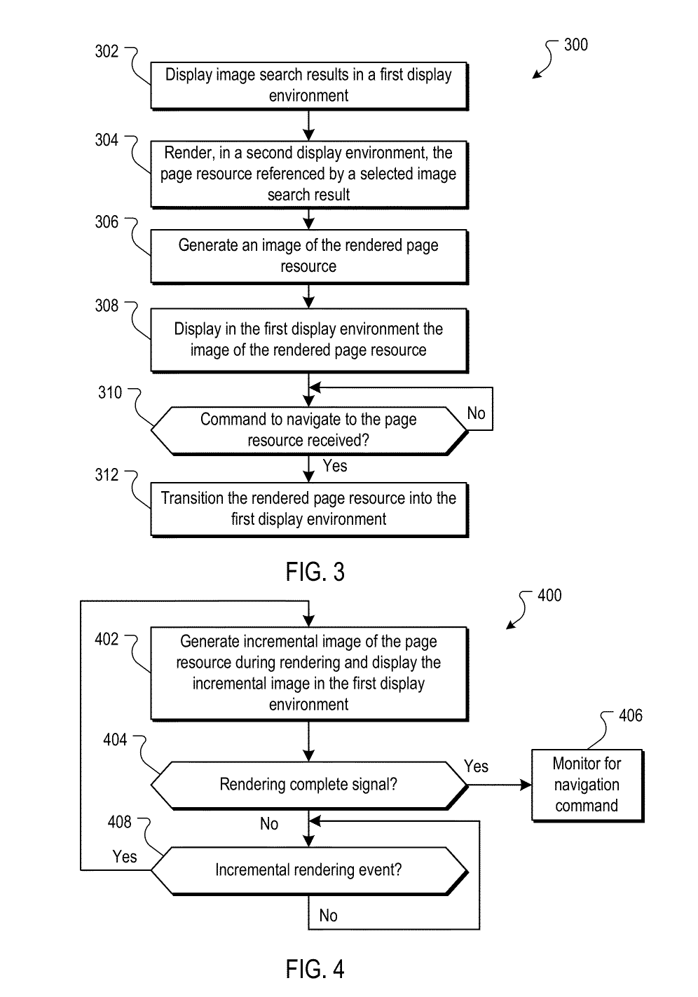

FIG. 3 is a flowchart of an example process 300 for processing an image search result. The process 300 can be implemented in a user device 106 executing instructions that cause the user device to perform the operations described below.

The process 300 displays image search results in a search results page displayed in a first display environment (302). The first display environment is a display environment in which content is displayed to a user, e.g., an active window or active tab in a browser. Each image search result references a corresponding image resource that is determined to be responsive to a search query, includes a representative image of the image resource, and also references a page resource that includes the image resource.

Selection of an image search result causes the user device to request the page resource. In response to a selection of one of the image search results, the process renders, in a second display environment, the page resource referenced by the selected image search result (304). The second display environment is a display environment that is separate from the first display environment, e.g., such as another browser tab or window. The second display environment can, in some implementations, be a hidden tab or hidden window.

The process 300 generates, from the rendered page resource in the second display environment, an image of the rendered page resource (306). For example, the browser, accessing and API to an image process, can generate an image from the data stored in memory of the rendered page resource. The image depicts the appearance of the page resource as if the page resource were displayed in a browser window.

The process 300 displays, in the first display environment, the image of the rendered page resource (308). For example, the image of the rendered page resource may be displayed by modifying the DOM of the search results page resource.

The process 300 monitors for a command to navigate to the page resource (310). For example, the process 300 monitors for a command to close the overlay 240 of FIG. 2B. The command to close also causes the browser to generate a command to navigate to the page resource.

In response to the command, the process 300 transitions the rendered page resource into the first display environment (312). For example, the browser may take the contents of the rendered page resource in memory and associate the active window with the contents. Alternatively, the browser simultaneously closes the first display environment and causes the second display environment to become the active display environment.

Often a page resource may take several seconds to background render. This is because the page resource may request data from other servers, the hosting server may be experiencing service lag, and other traffic and serving related reasons. Thus, in some implementations, the instructions cause the browser to generate incremental images of the background rendered page resource, and each incremental image is displayed. As each incremental image is displayed, any previously displayed incremental image is replaced with the current incremental image. This creates the appearance of the page resource loading in the first display environment.

One example process for displaying incrementally generated images is described with reference to FIG. 4, which is a flowchart of an example process 400 for generating and displaying incremental images. The process 400 can be implemented in a user device 106 executing instructions that cause the user device to perform the operations described below.

The process 400 generates an incremental image of the background rendered page resource and displays the incremental image in the first display environment (402). The process generates an incremental image in response to an incremental rendering event. Example incremental rendering events are incremental time period expirations (e.g., an expiration every 100 milliseconds), data reception (e.g., every 25 kilobytes received), or some other event, or combination of events, that can used to trigger the generation of an image of the currently rendered resource. As the incremental images are generated before the page resource is completely rendered, one or more of the incremental images of the background rendered page resource is an image of an incomplete set of content of the page resource. For example, a first incremental image may be of a label of an image in a page resource, but the image is not yet displayed. The second incremental image may be of the label and the image in the page resource.

The process 400 determine if a rendering complete signal exists (404). A rendering complete signal is a signal that stops the incremental rendering. For example, a rendering complete signal may be generated in response to the page resource being completely received; in response to a server time out of the serving the page resource; in response to a maximum time period (e.g., five seconds), or some other event.

If the process 400 determines a rendering complete signal exists, then the process 400 monitors for the navigation command (406), e.g., as described with reference to step 310 in FIG. 3.

Conversely, if the process 400 determines that the rendering complete signal does not exist, the process 400 determines if an incremental rendering event has occurred (408). If an incremental rendering event has occurred, the process 400 returns to step 402. Otherwise, the process waits for the next occurrence of an incremental rendering event.

Additional Features and Variations

Although specific examples have been described in the context of textual search queries, any type of user interface and image search algorithm can be used. For example, image search queries in the form of actual images can be used. Alternatively, voice input can be used to input text queries or to specify specific images as image queries.

Furthermore, the specific user interface features are merely examples of user interface environments in which the features described herein can be used. The features can also be adapted to many other user interface environments.

Although specific example have been described in the context of image search operations, the features can be applied to any type of search result for any corpus in which a portion of a resource of interest is to be shown in context with the underlying resource referenced by the search result.

Additional Implementation Details

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A non-transitory computer storage medium encoded with instructions that when executed by a user device cause the user device to perform operations comprising:
displaying, by the user device, a plurality of image search results in a search results page displayed in a first display environment, the first display environment being a display environment in which content is displayed to a user, each image search result referencing a corresponding image resource that is determined to be responsive to a search query and including a representative image of the image resource, and referencing a page resource that includes the image resource, and wherein a selection of an image search result causes the user device to request the page resource;
in response to a selection of one of the image search results:
requesting, by the user device, the page resource referenced by the selected image search result from a website hosting the page resource and receiving, by the user device, the page resource in response to the request, the page resource including instructions that reference the corresponding image resource and that causes a browser on the user device to render the image resource and additional content;
rendering, by the user device, the page resource referenced by the selected image search result and received in response to the selection of the image search result in a second display environment to generate a rendered page resource in the second display environment, the rendered page resource including the image and the additional content, the second display environment being a display environment that is separate from the first display environment and not displayed on the user device;
generating, by the user device and from the rendered page resource in the second display environment, an image of the rendered page resource, the image of the rendered page resource being of dimensions to depict the page resource at a size it will appear when rendered in the first display environment;
displaying, in the first display environment, the image of the rendered page resource; and
in response to a command to navigate to the page resource, transitioning the rendered page resource to the first display environment to display the page resource.

2. The non-transitory computer storage medium of claim 1, further comprising:
generating a selectable representative image of the image resource included in the image search result; and
generating the command to navigate to the page resource in response to a command to close the selectable representative image of the image resource.

3. The non-transitory computer storage medium of claim 1, wherein transitioning the rendered page resource to the first display environment to display the page resource comprises:
closing the first display environment; and
causing the second display environment to be the first display environment in which content is displayed to a user.

4. The non-transitory computer storage medium of claim 1, wherein transitioning the rendered page resource to the first display environment to display the page resource comprises:
removing the content of the search results page and the image of the rendered page resource from the first display environment; and
displaying the rendered page resource in the first display environment.

5. The non-transitory computer storage medium of claim 1, wherein displaying, in the first display environment, the image of the rendered page resource comprises:
inserting a Document Object Model (DOM) image element in a DOM of the search results page DOM, the inserted image element being the image of the rendered page resource.

6. The non-transitory computer storage medium of claim 1, wherein:
generating an image of the rendered page resource comprises generating incremental images of the rendered page resource in response to respective incremental rendering events, wherein one or more of the incremental images of the rendered page is an image of an incomplete set of content of the page resource, each incomplete set of the content of the page resource being the content that is rendered in the second display environment and prior to a complete rendering of the page resource; and
displaying, in the first display environment, the image of the rendered page resource comprises displaying each incremental images of the rendered page resource in the first display environment, wherein each incremental image that is displayed supersedes any previously displayed incremental image of the rendered page resource.

7. The non-transitory computer storage medium of claim 6, wherein an incremental rendering event is an expiration of an incremental time period.

8. A computer-implemented method, comprising:
displaying, at a user device, a plurality of image search results in a search results page displayed in a first display environment, the first display environment being a display environment in which content is displayed to a user, each image search result referencing a corresponding image resource that is determined to be responsive to a search query and including a representative image of the image resource, and referencing a page resource that includes the image resource, and wherein a selection of an image search result causes the user device to request the page resource;
in response to a selection of one of the image search results:
requesting, by the user device, the page resource referenced by the selected image search result from a website hosting the page resource and receiving, by the user device, the page resource in response to the request, the page resource including instructions that reference the corresponding image resource and that causes a browser on the user device to render the image resource and additional content;
rendering, at the user device, the page resource referenced by the selected image search result and received in response to the selection of the image search result in a second display environment to generate a rendered page resource in the second display environment, the rendered page resource including the image and the additional content, the second display environment being a display environment that is separate from the first display environment and not displayed on the user device;
generating, by the user device and from the rendered page resource in the second display environment, an image of the rendered page resource, the image of the rendered page resource being of dimensions to depict the page resource at a size it will appear when rendered in the first display environment;
displaying, in the first display environment, the image of the rendered page resource; and
in response to a command to navigate to the page resource, transitioning the rendered page resource to the first display environment to display the page resource.

9. The method of claim 8, further comprising:
generating a selectable representative image of the image resource included in the image search result; and
generating the command to navigate to the page resource in response to a command to close the selectable representative image of the image resource.

10. The method of claim 8, wherein transitioning the rendered page resource to the first display environment to display the page resource comprises:
closing the first display environment; and
causing the second display environment to be the first display environment in which content is displayed to a user.

11. The method of claim 8, wherein transitioning the rendered page resource to the first display environment to display the page resource comprises:
removing the content of the search results page and the image of the rendered page resource from the first display environment; and
displaying the rendered page resource in the first display environment.

12. The method of claim 8, wherein displaying, in the first display environment, the image of the rendered page resource comprises:
inserting a Document Object Model (DOM) image element in a DOM of the search results page DOM, the inserted image element being the image of the rendered page resource.

13. The method of claim 8, wherein:
generating an image of the rendered page resource comprises generating incremental images of the rendered page resource in response to respective incremental rendering events, wherein one or more of the incremental images of the rendered page is an image of an incomplete set of content of the page resource, each incomplete set of the content of the page resource being the content that is rendered in the second display environment and prior to a complete rendering of the page resource; and
displaying, in the first display environment, the image of the rendered page resource comprises displaying each incremental images of the rendered page resource in the first display environment, wherein each incremental image that is displayed supersedes any previously displayed incremental image of the rendered page resource.

14. The method of claim 13, wherein an incremental rendering event is an expiration of an incremental time period.

15. A system, comprising:
a data processing apparatus; and
a non-transitory computer storage medium in data communication with the data processing apparatus and encoded with instructions that when executed by the data processing apparatus cause the data processing apparatus to perform operations comprising:
displaying, by the data processing apparatus, a plurality of image search results in a search results page displayed in a first display environment, the first display environment being a display environment in which content is displayed to a user, each image search result referencing a corresponding image resource that is determined to be responsive to a search query and including a representative image of the image resource, and referencing a page resource that includes the image resource, and wherein a selection of an image search result causes the user device to request the page resource;
in response to a selection of one of the image search results:
requesting, by the data processing apparatus, the page resource referenced by the selected image search result from a website hosting the page resource and receiving, by the user device, the page resource in response to the request, the page resource including instructions that reference the corresponding image resource and that causes a browser on the user device to render the image resource and additional content;
rendering, by the data processing apparatus, the page resource referenced by the selected image search result and received in response to the selection of the image search result in a second display environment to generate a rendered page resource in the second display environment, the rendered page resource including the image and the additional content, the second display environment being a display environment that is separate from the first display environment and not displayed on the user device;
generating, by the data processing apparatus and from the rendered page resource in the second display environment, an image of the rendered page resource, the image of the rendered page resource being of dimensions to depict the page resource at a size it will appear when rendered in the first display environment;
displaying, in the first display environment, the image of the rendered page resource; and
in response to a command to navigate to the page resource, transitioning the rendered page resource to the first display environment to display the page resource.

16. The system of claim 15, the operations further comprising:
generating a selectable representative image of the image resource included in the image search result; and
generating the command to navigate to the page resource in response to a command to close the selectable representative image of the image resource.

17. The system of claim 15, wherein transitioning the rendered page resource to the first display environment to display the page resource comprises:
closing the first display environment; and
causing the second display environment to be the first display environment in which content is displayed to a user.

18. The system of claim 15, wherein transitioning the rendered page resource to the first display environment to display the page resource comprises:
removing the content of the search results page and the image of the rendered page resource from the first display environment; and
displaying the rendered page resource in the first display environment.

19. The system of claim 15, wherein displaying, in the first display environment, the image of the rendered page resource comprises:
inserting a Document Object Model (DOM) image element in a DOM of the search results page DOM, the inserted image element being the image of the rendered page resource.

20. The system of claim 15, wherein:
generating an image of the rendered page resource comprises generating incremental images of the rendered page resource in response to respective incremental rendering events, wherein one or more of the incremental images of the rendered page is an image of an incomplete set of content of the page resource, each incomplete set of the content of the page resource being the content that is rendered in the second display environment and prior to a complete rendering of the page resource; and
displaying, in the first display environment, the image of the rendered page resource comprises displaying each incremental images of the rendered page resource in the first display environment, wherein each incremental image that is displayed supersedes any previously displayed incremental image of the rendered page resource.

21-23. (canceled)
